(19) United States
(12) Patent Application Publication
(10) Pub. No.: US 2006/0001348 A1
(43) Pub. Date: Jan. 5, 2006

(54) Cathode ray tube

(75) Inventor: Sung Hun Kim, Kumi-si (KR)

Correspondence Address: BIRCH STEWART KOLASCH & BIRCH, PO BOX 747, FALLS CHURCH, VA, 22040-0747, US

(73) Assignee: LG. Philips Displays Korea CO., LTD., Kyungsangbuk-Do (KR)

(21) Appl. No.: 11/159,326

(22) Filed: Jun. 23, 2005

(30) Foreign Application Priority Data
Jun. 26, 2004 (KR) 2004-48669
Jun. 26, 2004 (KR) 2004-48670

(51) Int. Cl. H01J 29/07; H01J 29/81

(52) U.S. Cl. 313/407; 313/402

(57) ABSTRACT

A cathode ray tube in which an opening defined by an edge of a bottom wall of a frame has longer-axis, shorter-axis, and diagonal axis widths appropriately determined in accordance with a distance from a deflection center of a panel to an edge of a skirt of the panel, in order to eliminate problems such as an electron beam shielding phenomenon and a halation phenomenon.

### BACKGROUND OF THE INVENTION

1. Field of the Invention

The present invention relates to a cathode ray tube, and, more particularly, to a cathode ray tube in which an opening defined by an edge of a bottom wall of a frame has longer-axis, shorter-axis, and diagonal axis widths appropriately determined in accordance with a distance from a deflection center of a panel to an edge of a skirt of the panel, in order to eliminate problems such as an electron beam shielding phenomenon and a halation phenomenon.

2. Description of the Related Art

A conventional cathode ray tube will be described hereinafter with reference to FIG. 1.

FIG. 1 is a sectional view illustrating a structure of a conventional cathode ray tube. As shown in FIG. 1, the conventional cathode ray tube includes a panel 1, a funnel 2, a shadow mask 3, a screen 4, a deflection yoke 5, a frame 6, a spring 7, and an inner shield 8.

Operation of the cathode ray tube having the above-mentioned configuration will be described. An electron beam, which is emitted from an electron gun travels toward the panel 1, and is then vertically and horizontally deflected by the deflection yoke 5, which is arranged at a neck of the funnel 2.

The deflected electron beam passes through slots formed through the shadow mask 3, and reaches a phosphor surface coated on the screen 4. The phosphor surface emits light, using the energy of the electron beam, so that an image is reproduced.

The frame 6, which is also included in the cathode ray tube, supports the shadow mask 3. The spring 7 is arranged to tightly fit the frame 6 with an inner surface of the panel 1.

If the electron beam is influenced by an external geomagnetic field, the travel path of the electron beam is deflected, so that the color purity of the reproduced image is degraded. The inner shield 8, which is included in the cathode ray tube, is adapted to reduce the influence of the geomagnetic field.

The frame 6 includes a side wall, to which the shadow mask 3 is welded, and a bottom wall extending from one edge of the side wall in a state of being bent perpendicularly to the side wall. The bottom wall has an edge bent through a predetermined angle to form a reflecting tip.

Recently, cathode ray tubes have been advanced to have a slim structure, in order to enhance the competitiveness thereof. However, since such slim cathode ray tubes are unstable in terms of their structure, they must have enhanced qualities, as compared to conventional cases. In particular, problems incurred in cathode ray tubes due to their structures include a shape inconformity between a frame and a panel, a halation phenomenon, and a phenomenon wherein electron beams are shielded during an over-scanning operation, so that shade is formed on the screen of the panel.

In particular, the phenomenon wherein shade is formed on the screen of the panel due to shielding of electron beams occurring during an over-scanning operation, and the halation phenomenon are influenced by the structures of the side wall and bottom wall of the frame 6.

The bottom wall of the frame 6 extends from one edge of the side wall of the frame 6 in a state of being bent such that the bottom wall is substantially parallel to the panel 1. An opening is defined inside the bottom wall of the frame 6. An electron beam emitted from the electron gun travels while passing through the opening. The travel path of the electron beam may interfere with the frame 6 in accordance with the width of the bottom wall of the frame 6. For example, where the bottom wall of the frame 6 has an excessively large or small width, the electron beam may strikes the frame 6, so that shade is formed on the screen. That is, an electron beam shielding phenomenon may occur. A halation phenomenon may also occur due to secondary electrons generated when the electron beam strikes an inner surface of the frame 6.

In particular, where the frame 6 is applied to a slim cathode ray tube, it is necessary to appropriately design the structure of the frame 6 because the slim cathode ray tube has an increased deflection angle, as compared to that of general cathode ray tubes. However, since conventional slim cathode ray tubes use a frame having a conventional structure, they have problems caused by the electron beam shielding phenomenon or halation phenomenon, as described above.

### SUMMARY OF THE INVENTION

The present invention has been made in view of the problems incurred in the above-mentioned related art, and it is an object of the invention to provide a cathode ray tube in which an opening defined by an edge of a bottom wall of a frame has longer-axis, shorter-axis, and diagonal axis widths appropriately determined in accordance with a distance from a deflection center of a panel to an edge of a skirt of the panel, in order to eliminate problems such as an electron beam shielding phenomenon and a halation phenomenon.

In accordance with one aspect, the present invention provides a cathode ray tube comprising a panel, a funnel coupled to a rear end of the panel, a shadow mask formed with a plurality of slots to perform a color selecting function for electron beams, and a frame adapted to support the shadow mask, wherein: the frame comprises a side wall, to which the shadow mask is welded, and a bottom wall extending from the side wall in a state of being bent inwardly of the frame; and the cathode ray tube satisfies a condition “1.80≦Dx/L≦2.52” where “L” represents a distance from a deflection center of the cathode ray tube to an edge of a skirt of the panel in a direction parallel to a central axis (z) of the panel, and “Dx” represents a distance from the central axis (z) of the panel to an edge of the bottom wall of the frame in a direction parallel to the longer axis (x).

In accordance with another aspect of the present invention, the cathode ray tube satisfies a condition “0.90≦Dy/L≦1.41” where “Dy” represents a distance from the central axis (z) of the panel to the edge of the bottom wall of the frame in a direction parallel to the shorter axis (y).

In accordance with another aspect of the present invention, the cathode ray tube satisfies a condition “1.99≦Dd/L≦3.04” where “Dd” represents a distance from the central axis (z) of the panel to the edge of the bottom wall of the frame in a direction parallel to the diagonal axis (d).

The bottom wall of the frame may have an edge bent through a predetermined angle to form a reflecting tip. In this case, it is preferred that the cathode ray tube satisfy particular conditions to prevent occurrence of a halation phenomenon caused by secondary electrons generated when electron beams are reflected from the reflecting tip.

That is, the cathode ray tube may satisfy a condition “0.80≦θx/βx≦0.90” where “θx” represents a deflection angle, at which an electron beam strikes a reflecting surface of a reflecting tip of the frame extending along the longer axis (x), and “βx” represents an angle formed between a line extending perpendicularly to the longer-axis reflecting surface of the reflecting tip and the central axis (z) of the panel.

The cathode ray tube may also satisfy a condition “0.65≦θy/βy≦0.85” where “θy” represents a deflection angle, at which an electron beam strikes a reflecting surface of a reflecting tip of the frame extending along the shorter axis (y), and “βy” represents an angle formed between a line extending perpendicularly to the shorter-axis reflecting surface of the reflecting tip and the central axis (z) of the panel. The cathode ray tube may also satisfy a condition “0.80≦θd/βd≦0.95” where “θd” represents a deflection angle, at which an electron beam strikes a reflecting surface of a reflecting tip of the frame extending along the diagonal axis (d), and “βd” represents an angle formed between a line extending perpendicularly to the diagonal-axis reflecting surface of the reflecting tip and a central axis (z) of the panel.

In particular, the frame can exhibit desirable effects where the cathode ray tube, to which the frame is applied, has a slim structure. To this end, the distance (L) from the deflection center of the cathode ray tube to the edge of the skirt of the panel in the direction parallel to the central axis (z) of the panel may satisfy a condition “92 mm≦L≦144 mm”.

### BRIEF DESCRIPTION OF THE DRAWINGS

The above objects, and other features and advantages of the present invention will become more apparent after reading the following detailed description when taken in conjunction with the drawings, in which:

FIG. 1 is a sectional view illustrating a structure of a conventional cathode ray tube;

FIG. 2 is a sectional view illustrating a part of a cathode ray tube according to the present invention;

FIG. 3 is a perspective view of a frame, illustrating longer, shorter and diagonal axes of the frame;

FIG. 4 is a perspective view illustrating an opening formed through a frame included in the cathode ray tube according to the present invention and respective widths of the opening along the longer, shorter, and diagonal axes of the frame;

FIG. 5 is a sectional view of a part of the cathode ray tube according to the present invention, explaining an electron beam path determined by the reflecting tip;

FIG. 6 is a schematic view illustrating a slimness of the cathode ray tube according to the present invention; and

FIG. 7 is a schematic view illustrating the cross section of a yoke of a funnel applied to the cathode ray tube according to the present invention.

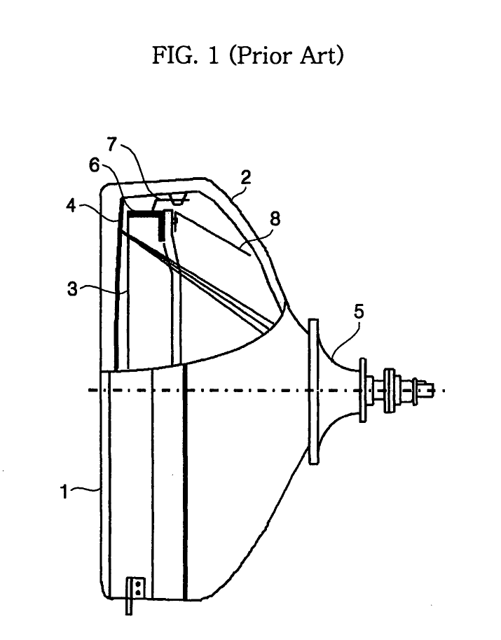

### DESCRIPTION OF THE PREFERRED EMBODIMENTS

Hereinafter, exemplary embodiments of a cathode ray tube according to the present invention will be described with reference to the annexed drawings. In the following description, the same elements are referred to by the same title and designated by the same reference numeral.

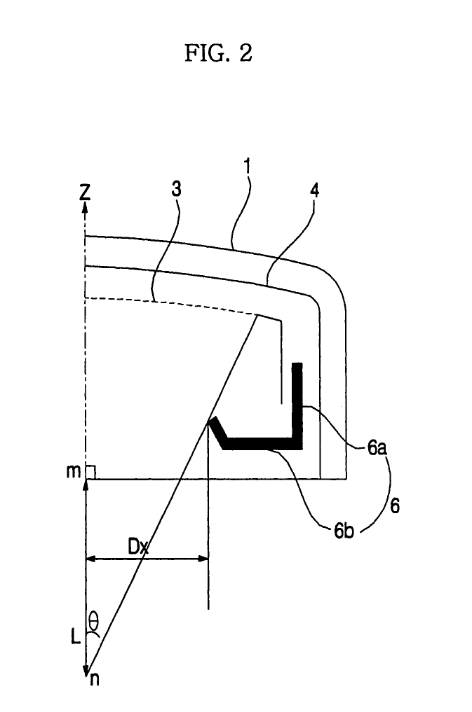

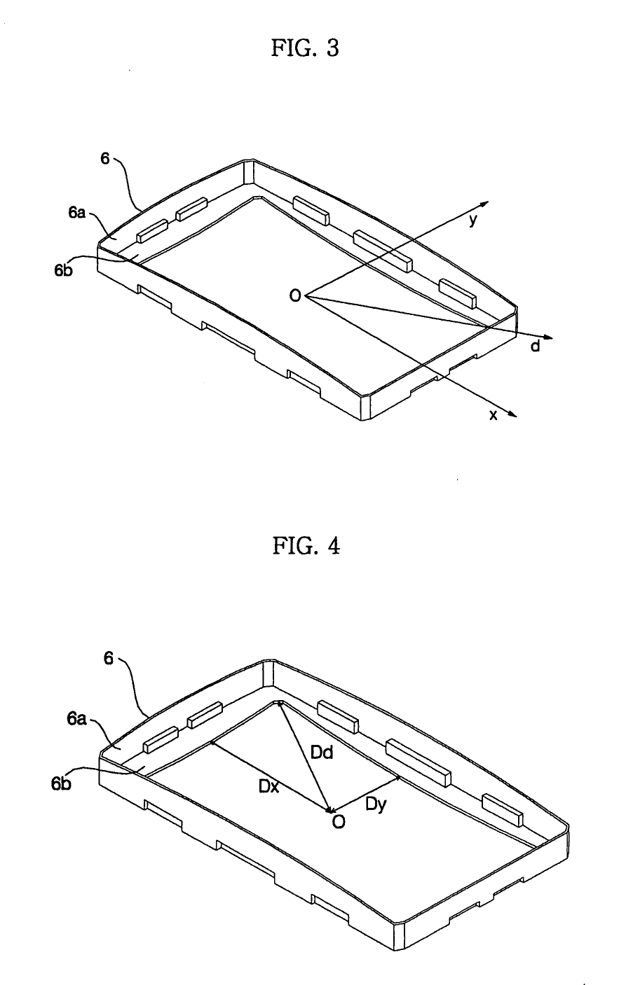

FIG. 2 is a sectional view illustrating a part of a cathode ray tube according to the present invention. FIG. 3 is a perspective view of a frame, illustrating longer, shorter and diagonal axes of the frame. FIG. 4 is a perspective view illustrating an opening formed through a frame included in the cathode ray tube according to the present invention and respective widths of the opening along the longer, shorter, and diagonal axes of the frame.

As shown in FIG. 2, the cathode ray tube according to the present invention includes a panel 1, a screen 4 formed on an inner surface of the panel 1, a shadow mask 3 formed with a plurality of slots, and a frame 6. FIG. 2 illustrates a cross section of the cathode ray tube taken along a direction parallel to a longer axis of the cathode ray tube.

In FIG. 2, “z” represents a central axis of the panel 1 extending through a center of the panel and a deflection center n of the panel 1. When a line extends in a direction parallel to the longer axis x of the panel 1 from an edge of a skirt extending perpendicularly from an effective screen portion of the panel 1 such that the line perpendicularly crosses the central axis z of the panel, the line meets the central axis z of the panel at a point m.

In this case, the distance from the deflection center n to the point m may be defined as “L”.

The frame 6 includes a side wall 6a, to which the shadow mask 3 is welded, and a bottom wall 6b extending from one edge of the side wall 6a in a bent state. The bottom wall 6b has an edge bent through a predetermined angle to form a reflecting tip.

The distance from the central axis z of the panel 1 to the edge of the bottom wall 6b of the frame 6 in a direction parallel to the longer axis x may be defined as “Dx”. In FIG. 2, “θ” represents a deflection angle of an electron beam passing through a certain slot of the shadow mask 3.

As shown in FIG. 3, the frame 6 has a substantially rectangular shape having a longer axis x, a shorter axis y, and a diagonal axis d. The longer axis x is an axis extending in parallel to the longer sides of the frame 6, the shorter axis y is an axis extending in parallel to the shorter sides of the frame 6, and the diagonal axis d is an axis extending between two opposite corners of the frame 6.

As shown in FIG. 4, the frame 6 has an opening defined inside the bottom wall 6b extending along the longer and shorter sides of the frame 6. The axes x, y and d of the frame 6 cross at a center o of the opening.

The center o of the opening is positioned on the central axis z of the panel 1. As shown in FIG. 4, the distance from the central axis z of the panel 1 to the edge of the bottom wall 6b of the frame 6 in a direction parallel to the shorter axis y may be defined as “Dy”, and the distance from the central axis z of the panel 1 to the edge of the bottom wall 6b of the frame 6 in a direction parallel to the diagonal axis d may be defined as “Dd”.

Accordingly, the opening defined by the sides of the bottom wall 6b has longer, shorter, and diagonal-axis widths respectively varying depending on variations in the longer, shorter, and diagonal-axis widths of the bottom wall 6b.

In order to enable the cathode ray tube to reproduce an image without any distortion of the image, it is necessary to appropriately design the widths of the bottom wall 6b defining the opening, through which electron beams pass. For example, where the bottom wall 6b of the frame 6 has an excessively large or small width, an electron beam shielding phenomenon or a halation phenomenon may occur.

In particular, where the cathode ray tube has a slim structure, the distance L between the deflection center n and the edge of the skirt of the panel 1 along the central axis z of the panel 1 is reduced, as compared to those of general cathode ray tubes. In this case, accordingly, it is necessary to appropriately design the distances Dx, Dy and Dd from the central axis z of the panel 1 to the edge of the bottom wall 6b of the frame 6 in directions parallel to respective axes. This will be described in detail with reference to Table 1.

TABLE 1

| | | | | | Conventional |
|---|---|---|---|---|---|
| | Example 1 | Example 2 | Example 3 | Example 4 | Case |
| L (mm) | 92 | 96 | 134.2 | 144 | 240.5 |
| Dx (mm) | 232.0 | 234.0 | 255.4 | 259.0 | 277.0 |
| Dy (mm) | 130.0 | 125.8 | 138.2 | 130.0 | 148.9 |
| Dd (mm) | 279.5 | 272.2 | 296.3 | 286.0 | 319.8 |
| Dx/L | 2.52 | 2.44 | 1.90 | 1.80 | 1.15 |
| Dy/L | 1.41 | 1.31 | 1.03 | 0.90 | 0.62 |
| Dd/L | 3.04 | 2.84 | 2.21 | 1.99 | 1.33 |

The values given in Table 1 are associated with the case in which the cathode ray tube has a size of 32 inches. These values may be applied to cathode ray tubes of other sizes, for example, 28 to 32 in., to produce desirable effects.

In the conventional cathode ray tube, which has a general structure other than a slim structure, the distance L between the deflection center n and the edge of the skirt of the panel along the central axis z of the panel is about 240 mm, as given in Table 1. In the slim cathode ray tubes according to the present invention, however, the distance L is about 92 mm in the case of Example 1, and about 144 mm in the case of Example 4.

In the case of a cathode ray tube having a slim structure, the deflection angle of electron beams increases. In this case, accordingly, it is necessary to increase the distances Dx, Dy, and Dd from the central axis z of the panel to the edge of the bottom wall of the frame in directions parallel to respective axes of the frame, depending on the distance L of the cathode ray tube.

In order to obtain desired widths of the opening in the slim cathode ray tube, the distances Dx, Dy, and Dd from the central axis z of the panel to the edge of the bottom wall of the frame in directions parallel to respective axes of the frame were determined to be 232.0 mm, 130.0 mm, and 279.5 mm in the case of Example 1, and 259.0 mm, 130.0 mm, and 286.0 mm in the case of Example 4.

Based on the distances L, Dx, Dy, and Dd, the values Dx/L, Dy/L, and Dd/L were determined to be 2.52, 1.41, and 3.04 in the case of Example 1, and 1.80, 0.90, and 1.99 in the case of Example 4. These values are higher than those of the conventional case.

Based on the data of Examples 1 to 4, it is preferred that the values Dx/L, Dy/L, and Dd/L satisfy conditions “1.08≦Dx/L≦2.52”, “0.90≦Dy/L≦1.41”, and “1.99≦Dd/L≦3.04”.

When the widths of the bottom wall 6b of the frame 6 are reduced such that the distances Dx, Dy, and Dd are excessively large, electron beams strike the inner surface of the frame 6, thereby producing secondary electrons, so that a halation phenomenon may occur due to the secondary electrons. On the other hand, when the widths of the bottom wall 6b are increased such that the distances Dx, Dy, and Dd are excessively small, an electron beam shielding phenomenon may occur.

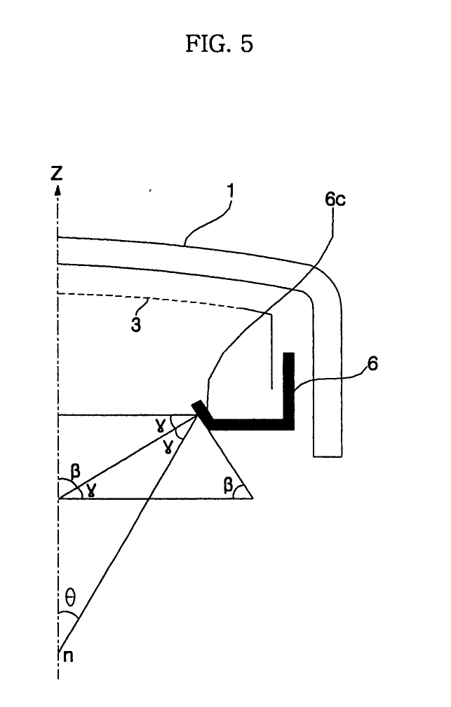

Meanwhile, it is also preferred that the cathode ray tube, which satisfies the above-described conditions, be configured to prevent occurrence of a halation phenomenon caused by a reflecting tip formed at the edge of the bottom wall of the frame. This will be described in detail with reference to FIG. 5.

FIG. 5 is a sectional view of a part of the cathode ray tube according to the present invention, explaining an electron beam path determined by the reflecting tip. In FIG. 5, the panel 1, shadow mask 3, screen 4, and frame 6 are shown. In particular, a reflecting tip 6c is formed at the edge of the bottom wall of the frame 6.

It is possible to prevent a halation phenomenon caused by electron beams striking the reflecting tip 6c by appropriately adjusting the angle of the reflecting tip 6c. This will be described in detail with reference to the following Table 2.

TABLE 2

| | | | | | Conventional |
|---|---|---|---|---|---|
| | Example 1 | Example 2 | Example 3 | Example 4 | Case |
| Θx | 65.0 | 63.2 | 58.2 | 54.0 | 45.3 |
| Θy | 55.0 | 47.3 | 41.6 | 38.8 | 29.3 |
| Θd | 70.0 | 66.7 | 62.0 | 56.0 | 49.8 |
| Bx | 72.2 | 71.6 | 69.1 | 67.8 | 62.7 |
| By | 64.4 | 63.6 | 60.8 | 59.4 | 54.7 |
| Bd | 73.9 | 73.3 | 71.0 | 69.7 | 64.9 |
| θx/βx | 0.90 | 0.88 | 0.84 | 0.80 | 0.72 |
| θy/βy | 0.85 | 0.74 | 0.68 | 0.65 | 0.54 |
| θd/βd | 0.95 | 0.91 | 0.87 | 0.80 | 0.77 |

In Table 2, “θx” represents a deflection angle, at which an electron beam strikes a reflecting surface of the reflecting tip 6c of the frame 6 extending along the longer axis x of the frame 6, and “βx” represents an angle formed between a line extending perpendicularly to the longer-axis reflecting surface of the reflecting tip 6c and the central axis z of the panel 1. Also, the angle formed between the line extending perpendicularly to a reflecting surface of the reflecting tip 6c and the travel direction of the electron beam may be defined as “γ”.

In Table 2, “θy” represents a deflection angle, at which an electron beam strikes a reflecting surface of the reflecting tip 6c of the frame 6 extending along the shorter axis y of the frame 6, and “βy” represents an angle formed between a line extending perpendicularly to the shorter-axis reflecting surface of the reflecting tip 6c and the central axis z of the panel 1. Also, “θd” represents a deflection angle, at which an electron beam strikes a reflecting surface of the reflecting tip 6c of the frame 6 extending along the diagonal axis d of the frame 6, and “βd” represents an angle formed between a line extending perpendicularly to the diagonal-axis reflecting surface of the reflecting tip 6c and the central axis z of the panel 1.

In order to effectively prevent occurrence of a halation phenomenon, the cathode ray tube has values θx and βx satisfying a condition “0.80≦θx/βx≦0.90”.

For the same purpose, the cathode ray tube has values θy and βy satisfying a condition “0.65≦θy/βy≦0.85”, and values θd and βd satisfying a condition “0.80≦θd/βd≦0.95”.

When the reflecting tip 6c is designed to satisfy the above-described conditions, electron beams, which strike the reflecting tip 6c, travel in directions perpendicular to the central axis z of the panel 1, respectively. Accordingly, it is possible to prevent electron beams from traveling toward the panel 1 after striking the reflecting tip 6c, and thus, to cope with problems caused by a halation phenomenon.

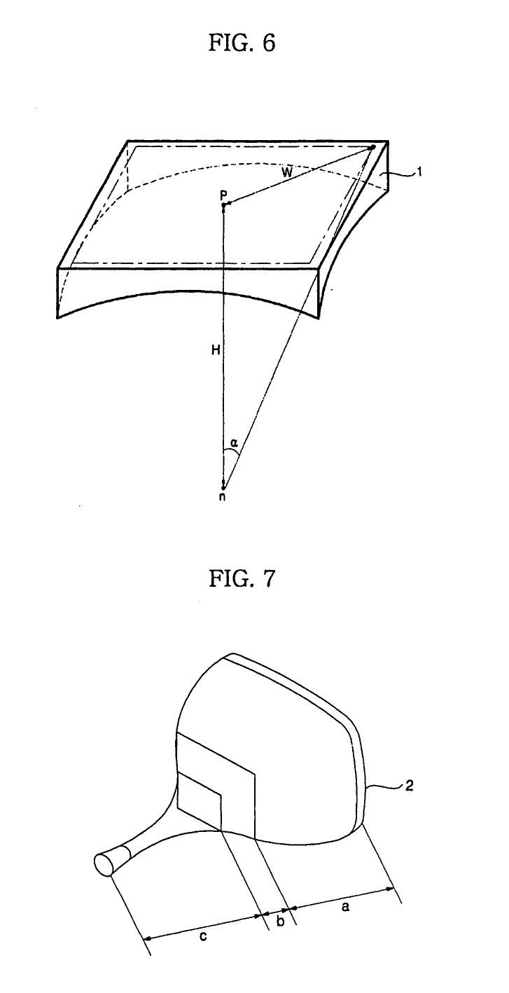

Meanwhile, where the cathode ray tube according to the present invention has a slim structure, the cathode ray tube can exhibit superior effects in accordance with the above-described structure improvement. This will be described in detail with reference to FIGS. 6 and 7.

FIG. 6 is a schematic view illustrating a slimness of the cathode ray tube according to the present invention. FIG. 7 is a schematic view illustrating the cross section of a yoke of a funnel applied to the cathode ray tube according to the present invention.

In FIG. 6, “H” represents the distance from a deflection center n of the cathode ray tube to a center P of the outer surface of a panel 1 included in the cathode ray tube, and “W” represents the distance from the outer surface center P of the panel 1 to an edge of the effective screen of the panel 1 in a diagonal direction of the panel 1.

When the values H and W satisfy a condition “tan⁻¹(W/H)≧1.05”, the cathode ray tube exhibits a deflection angle of about 120° or more. Here, the deflection angle corresponds to 2*α, and “α” represents an angle formed between a line extending from the deflection center n to the outer surface center P and a line extending from the deflection center n to an effective screen edge portion of the panel 1, through which a line extending from the outer surface center P in the diagonal direction of the panel 1 passes. When the cathode ray tube has a slim structure exhibiting a deflection angle of about 120° or more, it is possible to provide superior effects by applying the above-described structure improvement according to the present invention to the cathode ray tube.

Meanwhile, where the cathode ray tube has a slim structure, the deflection range of electron beams is widened due to an increase in deflection angle. As a result, the amount of current required to deflect electron beams is increased, so that consumption of electric power is increased.

In order to solve this problem, accordingly, it is necessary to reduce the amount of current required for deflection of electron beams. The current amount reduction may be achieved by appropriately modifying the funnel structure of the cathode ray tube. Referring to FIG. 7, a funnel 2 of the cathode ray tube is illustrated which includes a body a, a yoke b, and a neck c. In accordance with the present invention, it is possible to reduce the amount of current required for deflection of electron beams by design the funnel 2 such that the yoke b of the funnel 2 has a substantially rectangular vertical cross section.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

As apparent from the above description, the present invention provides a slim cathode ray tube in which an opening defined by an edge of a bottom wall of a frame has optimal longer-axis, shorter-axis, and diagonal axis widths, to eliminate problems such as an electron beam shielding phenomenon and a halation phenomenon.

In accordance with the present invention, it is also possible to prevent a halation phenomenon caused by electron beams striking a reflecting tip formed at the edge of the bottom wall of the frame by appropriately adjusting the angle of the reflecting tip.

What is claimed is:

1. A cathode ray tube comprising a panel, a funnel coupled to a rear end of the panel, a shadow mask formed with a plurality of slots to perform a color selecting function for electron beams, and a frame adapted to support the shadow mask, wherein:
the frame comprises a side wall, to which the shadow mask is welded, and a bottom wall extending from the side wall in a state of being bent inwardly of the frame; and
the cathode ray tube satisfies the following condition:
1.80≦Dx/L≦2.52
where, “L” represents a distance from a deflection center of the cathode ray tube to an edge of a skirt of the panel in a direction parallel to a central axis (z) of the panel, and “Dx” represents a distance from the central axis (z) of the panel to an edge of the bottom wall of the frame in a direction parallel to the longer axis (x).

2. The cathode ray tube according to claim 1, wherein the cathode ray tube satisfies the following condition:
0.90≦Dy/L≦1.41
where, “Dy” represents a distance from the central axis (z) of the panel to the edge of the bottom wall of the frame in a direction parallel to the shorter axis (y).

3. The cathode ray tube according to claim 1, wherein the cathode ray tube satisfies the following condition:
1.99≦Dd/L≦3.04
where, “Dd” represents a distance from the central axis (z) of the panel to the edge of the bottom wall of the frame in a direction parallel to the diagonal axis (d).

4. The cathode ray tube according to claim 1, wherein the cathode ray tube satisfies the following condition:
0.80≦θx/βx≦0.90
where, “θx” represents a deflection angle, at which an electron beam strikes a reflecting surface of a reflecting tip of the frame extending along the longer axis (x), and “θx” represents an angle formed between a line extending perpendicularly to the longer-axis reflecting surface of the reflecting tip and the central axis (z) of the panel.

5. The cathode ray tube according to claim 1, wherein the distance (L) from the deflection center of the cathode ray tube to the edge of the skirt of the panel in the direction parallel to the central axis (z) of the panel satisfies the following condition:
92 mm≧L≦144 mm.

6. The cathode ray tube according to claim 1, wherein the cathode ray tube satisfies the following condition:
tan⁻¹(W/H)≧1.05
where, “H” represents a distance from the deflection center of the cathode ray tube to a center of an outer surface of the panel, and “W” represents a distance from the outer surface center of the panel to an edge of an effective screen of the panel in a diagonal direction of the panel.

7. The cathode ray tube according to claim 1, wherein the funnel comprises a yoke having a substantially rectangular vertical cross-sectional shape.

8. A cathode ray tube comprising a panel, a funnel coupled to a rear end of the panel, a shadow mask formed with a plurality of slots to perform a color selecting function for electron beams, and a frame adapted to support the shadow mask, wherein:
the frame comprises a side wall, to which the shadow mask is welded, and a bottom wall extending from the side wall in a state of being bent inwardly of the frame; and
the cathode ray tube satisfies the following condition:
0.90≦Dy/L≦1.41
where, “L” represents a distance from a deflection center of the cathode ray tube to an edge of a skirt of the panel in a direction parallel to a central-axis (z) of the panel, and “Dy” represents a distance from the central axis (z) of the panel to an edge of the bottom wall of the frame in a direction parallel to the shorter axis (y).

9. The cathode ray tube according to claim 8, wherein the cathode ray tube satisfies the following condition:
1.99≦Dd/L≦3.04
where, “Dd” represents a distance from the central axis (z) of the panel to the edge of the bottom wall of the frame in a direction parallel to the diagonal axis (d).

10. The cathode ray tube according to claim 8, wherein the cathode ray tube satisfies the following condition:
0.65≦θy/βy≦0.85
PS where, “θy” represents a deflection angle, at which an electron beam strikes a reflecting surface of a reflecting tip of the frame extending along the shorter axis (y), and “βy” represents an angle formed between a line extending perpendicularly to the shorter-axis reflecting surface of the reflecting tip and the central axis (z) of the panel.

11. The cathode ray tube according to claim 8, wherein the distance (L) from the deflection center of the cathode ray tube to the edge of the skirt of the panel in the direction parallel to the central axis (z) of the panel satisfies the following condition:
92 mm≦L≦144 mm.

12. The cathode ray tube according to claim 8, wherein the cathode ray tube satisfies the following condition:
tan⁻¹(W/H)≧1.05
where, “H” represents a distance from the deflection center of the cathode ray tube to a center of an outer surface of the panel, and “W” represents a distance from the outer surface center of the panel to an edge of an effective screen of the panel in a diagonal direction of the panel.

13. The cathode ray tube according to claim 8, wherein the funnel comprises a yoke having a substantially rectangular vertical cross-sectional shape.

14. A cathode ray tube comprising a panel, a funnel coupled to a rear end of the panel, a shadow mask formed with a plurality of slots to perform a color selecting function for electron beams, and a frame adapted to support the shadow mask, wherein:
the frame comprises a side wall, to which the shadow mask is welded, and a bottom wall extending from the side wall in a state of being bent inwardly of the frame; and
the cathode ray tube satisfies the following condition:
1.99≦Dd/L≦3.04
where, “L” represents a distance from a deflection center of the cathode ray tube to an edge of a skirt of the panel in a direction parallel to a central-axis (z) of the panel, and “Dd” represents a distance from the central axis (z) of the panel to an edge of the bottom wall of the frame in a direction parallel to the diagonal axis (d).

15. The cathode ray tube according to claim 14, wherein the cathode ray tube satisfies the following conditions:
1.80≦Dx/L≦2.52, and
0.90≦Dy/L≦1.41
where, “Dx” represents a distance from the central axis (z) of the panel to the edge of the bottom wall of the frame in a direction parallel to the longer axis (x), and “Dy” represents a distance from the central axis (z) of the panel to the edge of the bottom wall of the frame in a direction parallel to the shorter axis (y).

16. The cathode ray tube according to claim 14, wherein the cathode ray tube satisfies the following condition:
0.80≦θd/βd≦0.95
where, “θd” represents a deflection angle, at which an electron beam strikes a reflecting surface of a reflecting tip of the frame extending along the diagonal axis (d), and “βd” represents an angle formed between a line extending perpendicularly to the diagonal-axis reflecting surface of the reflecting tip and a central axis (z) of the panel.

17. The cathode ray tube according to claim 14, wherein the distance (L) from the deflection center of the cathode ray tube to the edge of the skirt of the panel in the direction parallel to the central axis (z) of the panel satisfies the following condition:
92 mm≦L≦144 mm.

18. The cathode ray tube according to claim 14, wherein the cathode ray tube satisfies the following condition:
tan⁻¹(W/H)≧1.05
where, “H” represents a distance from the deflection center of the cathode ray tube to a center of an outer surface of the panel, and “W” represents a distance from the outer surface center of the panel to an edge of an effective screen of the panel in a diagonal direction of the panel.

19. The cathode ray tube according to claim 14, wherein the funnel comprises a yoke having a substantially rectangular vertical cross-sectional shape.
